(19) United States
(12) Patent Application Publication
(10) Pub. No.: US 2025/0384823 A1
(43) Pub. Date: Dec. 18, 2025

(54) SUB-PIXEL, DISPLAY DEVICE INCLUDING THE SAME, AND ELECTRONIC DEVICE INCLUDING THE SAME

(71) Applicant: Samsung Display Co., Ltd., Yongin-si (KR)

(72) Inventors: Yeon Kyung KIM, Yongin-si (KR); Kyung Bae KIM, Yongin-si (KR); Dong Woo KIM, Yongin-si (KR); Yong Hee LEE, Yongin-si (KR)

(21) Appl. No.: 19/205,756

(22) Filed: May 12, 2025

(30) Foreign Application Priority Data
Jun. 17, 2024 (KR) 10-2024-0078148
Aug. 29, 2024 (KR) 10-2024-0116761

(51) Int. Cl. G09G 3/32

(52) U.S. Cl. CPC G09G 3/32; G09G 2300/0819; G09G 2310/0267

(57) ABSTRACT

A sub-pixel includes a first transistor connected between a first power voltage node and a first node, and including a gate terminal connected to a second node, a second transistor connected between the second node and a data line, and including a gate terminal connected to a first sub-gate line, a fourth transistor connected between the first node and an initialization voltage node, and including a gate terminal connected to a second sub-gate line, and a light-emitting element connected between the first node and a second power voltage node, wherein a logic low level of a first sub-gate signal configured to be received by the first sub-gate line is different from a logic low level of a second sub-gate signal configured to be received by the second sub-gate line.

### CROSS-REFERENCE TO RELATED APPLICATION

The present application claims priority to, and the benefit of, Korean Patent Application No. 10-2024-0078148, filed on Jun. 17, 2024, and Korean Patent Application No. 10-2024-0116761, filed on Aug. 29, 2024, in the Korean Intellectual Property Office, the entire disclosures of which are incorporated herein by reference.

### BACKGROUND

### 1. Field

The disclosure relates to a sub-pixel, a display device including the same, and electronic device including the same.

### 2. Description of the Related Art

As information technology is developed, importance of a display device, which is a connection medium between a user and information, has been highlighted. In response to this, a use of a display device such as a liquid crystal display device and an organic light-emitting display device is increasing.

Recently, a head-mounted display device (HMD) is being developed. The HMD is a display device that is worn by a user in a form of glasses or a helmet, and implements virtual reality (VR) or augmented reality (AR) in which a focus is formed at a distance close to eyes. A high-resolution panel is applied to the HMD, and thus a sub-pixel applicable to the high-resolution panel is required.

### SUMMARY

An object of the disclosure is to provide a sub-pixel and a display device including the same, and electronic device including the same applicable to a high-resolution panel.

According to one or more embodiments of the disclosure, a sub-pixel may include a first transistor connected between a first power voltage node and a first node, and including a gate terminal connected to a second node, a second transistor connected between the second node and a data line, and including a gate terminal connected to a first sub-gate line, a fourth transistor connected between the first node and an initialization voltage node, and including a gate terminal connected to a second sub-gate line, and a light-emitting element connected between the first node and a second power voltage node, wherein a logic low level of a first sub-gate signal configured to be received by the first sub-gate line is different from a logic low level of a second sub-gate signal configured to be received by the second sub-gate line.

A voltage of the logic low level of the second sub-gate signal may be less than a voltage of the logic low level of the first sub-gate signal.

An initialization voltage of the initialization voltage node may be less than a voltage of the logic low level of the first sub-gate signal.

The initialization voltage may be greater than or equal to a voltage of the logic low level of the second sub-gate signal.

The sub-pixel may further include a third transistor connected between the first power voltage node and a third node, and including a gate terminal connected to an emission control line, wherein the first transistor is connected between the third node and the first node.

The logic low level of the second sub-gate signal configured to be received by the second sub-gate line may be different from a logic low level of an emission control signal configured to be received by the emission control line.

A voltage of the logic low level of the second sub-gate signal may be less than a voltage of the logic low level of the emission control signal.

The initialization voltage may be less than the voltage of the logic low level of the emission control signal.

The first transistor, the second transistor, and the third transistor may include a metal-oxide-semiconductor field-effect transistor including a body electrode.

A first power voltage configured to be received by the first power voltage node may be configured to be supplied to the body electrode of the first transistor, the second transistor, and the third transistor.

The sub-pixel may further include a first capacitor connected between the second node and the third node, a second capacitor connected between the second node and a reference power voltage node, and a third capacitor connected between the first node and the second node.

According to one or more embodiments of the disclosure, a display device may include a display panel including a sub-pixel connected to a first sub-gate line and to a second sub-gate line, a first sub-gate driver configured to supply a first sub-gate signal to the sub-pixel through the first sub-gate line, and a second sub-gate driver configured to supply a second sub-gate signal to the sub-pixel through the second sub-gate line, wherein the sub-pixel includes a first transistor connected between a first power voltage node and a first node, and including a gate terminal connected to a second node, a second transistor connected between the second node and a data line, and including a gate terminal connected to the first sub-gate line, a fourth transistor connected between the first node and an initialization voltage node, and including a gate terminal connected to the second sub-gate line, and a light-emitting element connected between the first node and a second power voltage node, and wherein a logic low level of the first sub-gate signal is different from a logic low level of the second sub-gate signal.

A voltage of the logic low level of the second sub-gate signal may be less than a voltage of the logic low level of the first sub-gate signal.

An initialization voltage of the initialization voltage node may be less than a voltage of the logic low level of the first sub-gate signal.

The initialization voltage may be greater than or equal to a voltage of the logic low level of the second sub-gate signal.

The display device may further include an emission driver configured to supply an emission control signal to the sub-pixel through an emission control line, wherein the sub-pixel further includes a third transistor connected between the first power voltage node and a third node, and including a gate terminal connected to the emission control line, and wherein the first transistor is connected between the third node and the first node.

The logic low level of the second sub-gate signal configured to be received by the second sub-gate line may be different from a logic low level of the emission control signal configured to be received by the emission control line.

A voltage of the logic low level of the second sub-gate signal may be less than a voltage of the logic low level of the emission control signal.

The initialization voltage may be less than the voltage of the logic low level of the emission control signal.

The display device may further include a first capacitor connected between the second node and the third node, a second capacitor connected between the second node and a reference power voltage node, and a third capacitor connected between the first node and the second node.

According to one or more embodiments of the disclosure, an electronic device may include a sub-pixel including a first transistor connected between a first power voltage node and a first node, and including a gate terminal connected to a second node, a second transistor connected between the second node and a data line, and including a gate terminal connected to a first sub-gate line, a fourth transistor connected between the first node and an initialization voltage node, and including a gate terminal connected to a second sub-gate line, and a light-emitting element connected between the first node and a second power voltage node, wherein a logic low level of a first sub-gate signal configured to be received by the first sub-gate line is different from a logic low level of a second sub-gate signal configured to be received by the second sub-gate line.

The electronic device may include a smartphone, a television, a monitor, a tablet, an electric vehicle, a mobile phone, a tablet personal computer (PC), a mobile communication terminal, an electronic notebook, an electronic book, a portable multimedia player (PMP), a navigation device, an ultra-mobile PC (UMPC), a laptop computer, a billboard, an Internet of Things (IoT) device, a smartwatch, a watch phone, a head-mounted display (HMD), a virtual reality (VR) device, or an augmented reality (AR) device.

According to a sub-pixel and a display device including the same according to embodiments of the disclosure, the sub-pixel may be implemented using a transistor (for example, a MOSFET) suitable for black grayscale expression.

However, aspects of the disclosure is not limited to the above-described aspects, and may be variously expanded without departing from the spirit and scope of the disclosure.

### BRIEF DESCRIPTION OF THE DRAWINGS

The above and other aspects of the disclosure will become more apparent by describing in further detail embodiments thereof with reference to the accompanying drawings, in which:

FIG. 1 is a drawing illustrating a transistor according to one or more embodiments of the disclosure;

FIG. 2 is a block diagram illustrating a display device according to one or more embodiments of the disclosure;

FIG. 3 is a block diagram illustrating one or more embodiments of one of sub-pixels of FIG. 2;

FIG. 4 is a circuit diagram illustrating one or more embodiments of the sub-pixel of FIG. 3;

FIG. 5 is a block diagram illustrating one or more embodiments of a gate driver and a voltage generator shown in FIG. 2;

FIG. 6 is a block diagram illustrating one or more embodiments of a display system;

FIG. 7 is a perspective view illustrating an application example of the display system of FIG. 6; and

FIG. 8 is a drawing illustrating a head-mounted display device worn by a user of FIG. 7.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection.

For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

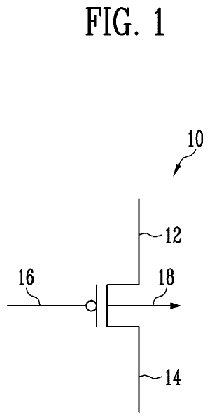

FIG. 1 is a drawing illustrating a transistor according to one or more embodiments of the disclosure.

Referring to FIG. 1, the transistor 10 according to one or more embodiments of the disclosure may include a first electrode 12, a second electrode 14, a gate electrode 16, and a body electrode 18. For example, the transistor 10 may be a metal-oxide-semiconductor field-effect transistor (MOSFET). The transistor 10 including the body electrode 18 (for example, a MOSFET) has a relatively small mount area, and may be suitable for implementing a high-resolution pixel.

The transistor 10 may be formed on a silicon wafer. For example, a panel may be implemented by stacking a transistor layer, a light-emitting layer, a cover layer, and the like on the silicon wafer. However, this is only an example, and the transistor 10 may be formed on various currently known substrates (for example, a glass substrate).

A gate on voltage may be a voltage of a gate signal that the transistor 10 may be turned on. A gate off voltage may be a voltage that the transistor 10 may be turned off.

In a P-type transistor 10, the gate on voltage may be a logic low level, and the gate off voltage may be a logic high level. In an N-type transistor 10, the gate on voltage may be a logic high level, and the gate off voltage may be a logic low level.

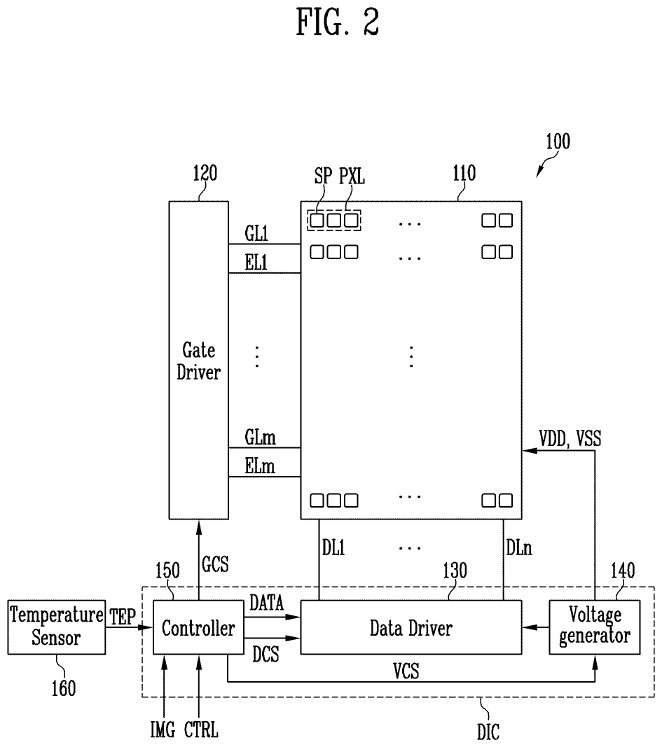

FIG. 2 is a block diagram illustrating one or more embodiments of a display device.

Referring to FIG. 2, the display device 100 may include a display panel 110, a gate driver 120, a data driver 130, a voltage generator 140, and a controller 150.

The display panel 110 includes sub-pixels SP. The sub-pixels SP may be connected to the gate driver 120 through first to m-th gate lines GL1 to GLm. The sub-pixels SP may be connected to the data driver 130 through first to n-th data lines DL1 to DLn.

Each of the sub-pixels SP may include at least one light-emitting element configured to generate light. Accordingly, each of the sub-pixels SP may generate light of a corresponding color such as red, green, blue, cyan, magenta, or yellow. Two or more sub-pixels among the sub-pixels SP may configure one pixel PXL. For example, as shown in FIG. 2, three sub-pixels may configure one pixel PXL.

The gate driver 120 is connected to the sub-pixels SP arranged in a row direction through the first to m-th gate lines GL1 to GLm. The gate driver 120 may output gate signals to the first to m-th gate lines GL1 to GLm in response to a gate control signal GCS. In embodiments, the gate control signal GCS may include a start signal indicating a start of each frame, a horizontal synchronization signal for outputting the gate signals in synchronization with a timing at which data signals are applied, and the like.

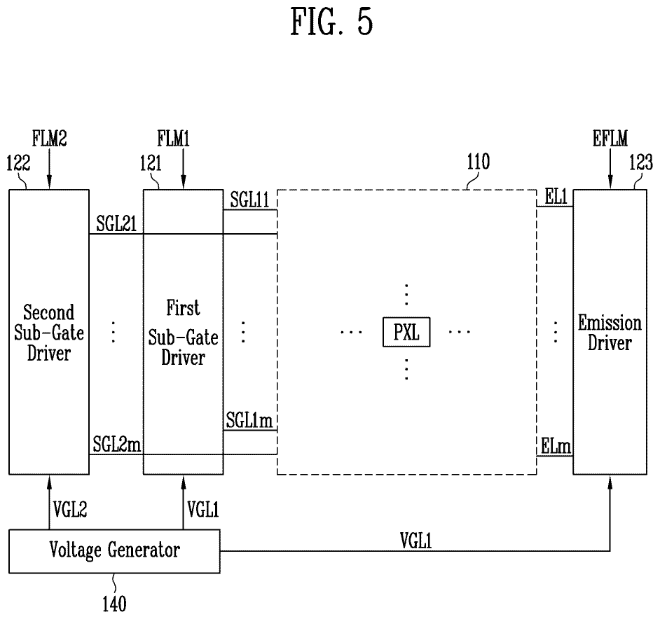

In embodiments, first to m-th emission control lines EL1 to ELm connected to the sub-pixels SP of the row direction may be further provided. In this case, the gate driver 120 may include an emission driver configured to control the first to m-th emission control lines EL1 to ELm, and the emission driver may operate under control of the controller 150. A more detailed description thereof is described later together with FIG. 5.

The gate driver 120 may be located on one side of the display panel 110. However, embodiments are not limited thereto. For example, the gate driver 120 may be divided into two or more physically and/or logically divided drivers, and such drivers may be located on one side of the display panel 110 and another side of the display panel 110 opposite the one side. As described above, the gate driver 120 may be located around the display panel 110 in various shapes according to embodiments.

The data driver 130 is connected to the sub-pixels SP arranged in a column direction through the first to n-th data lines DL1 to DLn. The data driver 130 receives image data DATA and a data control signal DCS from the controller 150. The data driver 130 operates in response to the data control signal DCS. In embodiments, the data control signal DCS may include a source start pulse, a source shift clock, a source output enable signal, and the like.

The data driver 130 may apply data signals having grayscale voltages corresponding to the image data DATA to the first to n-th data lines DL1 to DLn using voltages from the voltage generator 140. When the gate signal is applied to each of the first to m-th gate lines GL1 to GLm, the data signals corresponding to the image data DATA may be applied to the data lines DL1 to DLm. Accordingly, the corresponding sub-pixels SP may generate light corresponding to the data signals. Accordingly, an image is displayed on the display panel 110.

In embodiments, the gate driver 120 and the data driver 130 may include complementary metal-oxide semiconductor (CMOS) circuit elements.

The voltage generator 140 may operate in response to a voltage control signal VCS from the controller 150. The voltage generator 140 is configured to generate a plurality of voltages and provide the generated voltages to components of the display device 100. For example, the voltage generator 140 may be configured to generate the plurality of voltages by receiving an input voltage from an outside of the display device 100, adjusting the received voltage, and regulating the adjusted voltage.

The voltage generator 140 may generate a first power voltage VDD and a second power voltage VSS, and the generated first and second power voltages VDD and VSS may be provided to the sub-pixels SP. The first power voltage VDD may have a relatively high voltage level, and the second power voltage VSS may have a voltage level that is lower than that of the first power voltage VDD. In other embodiments, the first power voltage VDD or the second power voltage VSS may be provided by an external device of the display device 100.

In addition, the voltage generator 140 may generate various voltages. For example, the voltage generator 140 may generate an initialization voltage applied to the sub-pixels SP. For example, during a sensing operation for sensing electrical characteristics of transistors and/or light-emitting elements of the sub-pixels SP, a reference voltage (e.g., a predetermined reference voltage) may be applied to the first to n-th data lines DL1 to DLn, and the voltage generator 140 may generate such a reference voltage.

The controller 150 controls overall operations of the display device 100. The controller 150 receives input image data IMG and a control signal CTRL for controlling display of the input image data IMG from the outside. The controller 150 may provide the gate control signal GCS, the data control signal DCS, and the voltage control signal VCS in response to the control signal CTRL.

The controller 150 may convert the input image data IMG so that the input image data IMG is suitable for the display device 100 or the display panel 110, and may output the image data DATA. In embodiments, the controller 150 may output the image data DATA by aligning the input image data IMG so that the input image data IMG is suitable for the sub-pixels SP of a row unit.

Two or more components of the data driver 130, the voltage generator 140, and the controller 150 may be mounted on one integrated circuit. As shown in FIG. 1, the data driver 130, the voltage generator 140, and the controller 150 may be included in a driver integrated circuit DIC. In this case, the data driver 130, the voltage generator 140, and the controller 150 may be functionally divided components in one driver integrated circuit DIC. In other embodiments, at least one of the data driver 130, the voltage generator 140, and the controller 150 may be provided as a component distinguished from the driver integrated circuit DIC.

The display device 100 may include at least one temperature sensor 160. The temperature sensor 160 is configured to sense a temperature around the temperature sensor 160, and may generate temperature data TEP indicating the sensed temperature. In embodiments, the temperature sensor 160 may be located adjacent to the display panel 110 and/or the driver integrated circuit DIC.

The controller 150 may control various operations of the display device 100 in response to the temperature data TEP. In embodiments, the controller 150 may adjust a luminance of the image output from the display panel 110 in response to the temperature data TEP. For example, the controller 150 may control the data signals and the first and second power voltages VDD and VSS by controlling components such as the data driver 130 and/or the voltage generator 140.

A display device 100 according to one or more embodiments is a device that displays a moving image and/or a still image. The display device 100 may be applied to portable electronic devices such as mobile phones, smartphones, tablet personal computers (PCs), mobile communication terminals, electronic notebooks, electronic books, portable multimedia players (PMPs), navigations, and ultra-mobile PCs (UMPCs). For example, the display device 100 may be applied to a display unit of a television, a laptop computer, a monitor, a billboard, or the Internet of Things (IoT). Alternatively, in one or more embodiments, the display device 100 may be applied to a smartwatch, a watch phone, a virtual reality (VR) device, an augmented reality (AR) device, and/or a head-mounted display device (HMD) (e.g., for implementing virtual reality and/or augmented reality).

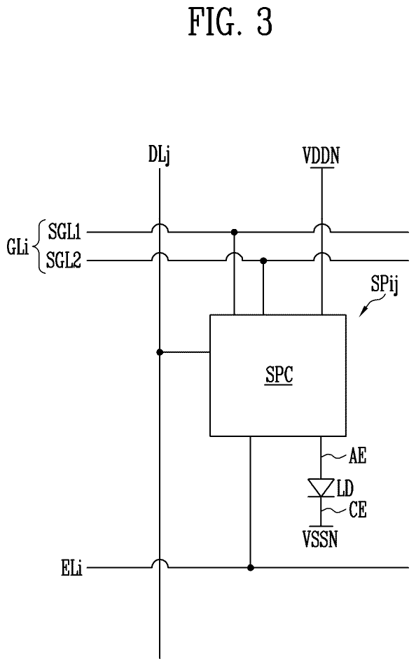

FIG. 3 is a block diagram illustrating an example of one of the sub-pixels of FIG. 2. In FIG. 3, among the sub-pixels SP of FIG. 2, a sub-pixel SPij arranged in an i-th row (i is an integer greater than or equal to 1 and less than or equal to m) and a j-th column (j is an integer greater than or equal to 1 and less than or equal to n) is shown as an example.

Referring to FIG. 3, the sub-pixel SPij may include a sub-pixel circuit SPC and a light-emitting element LD.

The light-emitting element LD is connected between a first power voltage node VDDN and a second power voltage node VSSN. At this time, the first power voltage node VDDN is a node that transfers the first power voltage VDD of FIG. 2, and the second power voltage node VSSN is a node that transfers the second power voltage VSS of FIG. 2.

An anode electrode AE of the light-emitting element LD may be connected to the first power voltage node VDDN through the sub-pixel circuit SPC, and a cathode electrode CE of the light-emitting element LD may be connected to the second power voltage node VSSN. For example, the anode electrode AE of the light-emitting element LD may be connected to the first power voltage node VDDN through one or more transistors included in the sub-pixel circuit SPC.

The sub-pixel circuit SPC may be connected to an i-th gate line GLi among the first to m-th gate lines GL1 to GLm of FIG. 2, an i-th emission control line ELi among the first to m-th emission control lines EL1 to ELm of FIG. 2, and a j-th data line DLj among the first to n-th data lines DL1 to DLn of FIG. 2. The sub-pixel circuit SPC is configured to control the light-emitting element LD according to signals received through such signal lines.

The sub-pixel circuit SPC may operate in response to a gate signal received through the i-th gate line GLi. The i-th gate line GLi may include one or more sub-gate lines. In embodiments, as shown in FIG. 3, the i-th gate line GLi may include first and second sub-gate lines SGL1 and SGL2. The sub-pixel circuit SPC may operate in response to gate signals received through the first and second sub-gate lines SGL1 and SGL2. As described above, when the i-th gate line GLi includes two or more sub-gate lines, the sub-pixel circuit SPC may operate in response to gate signals received through the corresponding sub-gate lines.

The sub-pixel circuit SPC may operate in response to an emission control signal received through the i-th emission control line ELi. In embodiments, the i-th emission control line ELi may include one or more sub-emission control lines. When the i-th emission control line ELi includes two or more sub-emission control lines, the sub-pixel circuit SPC may operate in response to emission control signals received through the corresponding sub-emission control lines.

The sub-pixel circuit SPC may receive a data signal through the j-th data line DLj. The sub-pixel circuit SPC may store a voltage corresponding to the data signal in response to at least one of the gate signals received through the first and second sub-gate lines SGL1 and SGL2. The sub-pixel circuit SPC may adjust a current flowing from the first power voltage node VDDN to the second power voltage node VSSN through the light-emitting element LD according to the stored voltage, in response the emission control signal received through the i-th emission control line ELi. Accordingly, the light-emitting element LD may generate light of a luminance corresponding to the data signal.

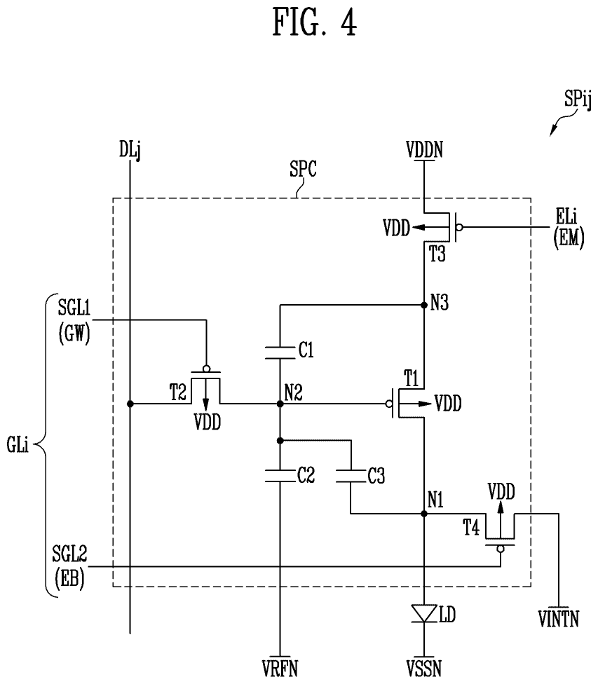

FIG. 4 is a circuit diagram illustrating one or more embodiments of the sub-pixel of FIG. 3.

Referring to FIG. 4, the sub-pixel SPij may include the sub-pixel circuit SPC and the light-emitting element LD.

The sub-pixel circuit SPC may be connected to the i-th gate line GLi, the i-th emission control line ELi, and the j-th data line DLj.

The sub-pixel circuit SPC may include first to fourth transistors T1 to T4, a first capacitor C1, a second capacitor C2, and a third capacitor C3.

The first transistor T1 is connected between the first power voltage node VDDN and a first node N1. A gate of the first transistor T1 is connected to a second node N2, and thus the first transistor T1 may be turned on according to a voltage level of the second node N2. The first transistor T1 may be referred to as a driving transistor.

The second transistor T2 is connected between the j-th data line DLj and the second node N2. A gate of the second transistor T2 may be connected to the first sub-gate line SGL1 and thus, the second transistor T2 may be turned on in response to the first sub-gate signal GW of the first sub-gate line SGL1. A timing at which the data signal transmitted through the j-th data line DLj to the second node N2 is applied may be controlled by the first sub-gate signal GW. The second transistor T2 may be referred to as a switching transistor.

The third transistor T3 is connected between the first power voltage node VDDN and a third node N3. A gate of the third transistor T3 may be connected to the emission control line ELi, and thus the third transistor T3 may be turned on in response to an emission control signal EM of the emission control line ELi. A timing at which the first power voltage node VDDN and the third node N3 are connected may be controlled by the emission control signal EM. In embodiments, the first transistor T1 may be connected between the third node N3 and the first node N1.

The fourth transistor T4 is connected between the first node N1 (that is, the anode electrode of the light-emitting element LD) and an initialization voltage node VINTN. The initialization voltage node VINTN is configured to transmit the initialization voltage. The initialization voltage may be greater than or equal to a voltage of a logic low level of the second sub-gate signal EB.

In embodiments, the initialization voltage may be provided by the voltage generator 140 of FIG. 1. In other embodiments, the initialization voltage may be provided by an external device of the display device 100.

In embodiments, the first power voltage may be supplied to a body electrode of each of the first to fourth transistors T1 to T4.

A gate of the fourth transistor T4 may be connected to the second sub-gate line SGL2, and thus the fourth transistor T4 may be turned on in response to the second sub-gate signal EB of the second sub-gate line SGL2. A timing at which the initialization voltage node VINTN and the first node N1 are connected may be controlled by the second sub-gate signal EB.

The logic low level of the second sub-gate signal EB may be separated from the first sub-gate signal GW and the emission control signal EM. That is, the logic low level of the second sub-gate signal EB may be different from a logic low level of the first sub-gate signal GW and a logic low level of the emission control signal EM.

In embodiments, a voltage of the logic low level of the second sub-gate signal EB may be less than a voltage of the logic low level of the first sub-gate signal GW. In addition, the voltage of the logic low level of the second sub-gate signal EB may be less than a voltage of the logic low level of the emission control signal EM.

For example, the voltage of the logic low level of the second sub-gate signal EB may be about −4.3 V, and a voltage of the logic low level of the first sub-gate signal GW and the emission control signal EM may be about −1.5 V.

Accordingly, a withstand voltage of the fourth transistor T4 to which the second sub-gate signal EB is applied may avoid becoming excessive, and reliability of an operation of the pixel may be improved.

Because the logic low level of the second sub-gate signal EB may be set to be less than the logic low level of the first sub-gate signal GW and the emission control signal EM, the initialization voltage may be set to be less than the voltage of the logic low level of the first sub-gate signal GW and the emission control signal EM.

For example, when the logic low level of the second sub-gate signal EB is not separated from the first sub-gate signal GW and the emission control signal EM, and the logic low level of the second sub-gate signal EB is set to about −1.5 V, the initialization voltage may not be less than about −1.5 V. However, when the logic low level of the second sub-gate signal EB is separated from the first sub-gate signal GW and the emission control signal EM, and the logic low level of the second sub-gate signal EB is set to about −4.3 V, the initialization voltage may be less than about −1.5 V. Accordingly, black grayscale expression of the pixel may become accurate.

A voltage of a logic high level of the second sub-gate signal EB may be equal to a voltage of a logic high level of the first sub-gate signal GW and a voltage of a logic high level of the emission control signal EM.

The first capacitor C1 is connected between the second node N2 and the third node N3. The second capacitor C2 is connected between the second node N2 and a reference voltage node VRFN. The reference voltage node VRFN is configured to transmit the reference voltage. In embodiments, the reference voltage may be provided by the voltage generator 140 of FIG. 1. The third capacitor C3 is connected between the first node N1 and the second node N2.

As described above, the sub-pixel circuit SPC may include the first to fourth transistors T1 to T4 and the first to third capacitors C1, C2, and C3. However, embodiments are not limited thereto.

The sub-pixel circuit SPC may be implemented as one of various types of circuits including a plurality of transistors and one or more capacitors. For example, the sub-pixel circuit SPC may include two transistors and one capacitor. According to embodiments of the sub-pixel circuit SPC, the number of sub-gate lines included in the i-th gate line GLi and the number of sub-emission control lines included in the i-th emission control line ELi may vary.

The first to fourth transistors T1 to T4 may be P-type transistors. Each of the first to fourth transistors T1 to T4 may be a metal oxide silicon field effect transistor (MOSFET).

However, embodiments are not limited thereto. For example, at least one of the first to fourth transistors T1 to T4 may be replaced with an N-type transistor.

In embodiments, the first to fourth transistors T1 to T4 may include an amorphous silicon semiconductor, a monocrystalline silicon, a polycrystalline silicon semiconductor, an oxide semiconductor, or the like.

The light-emitting element LD may include an anode electrode, a cathode electrode, and a light-emitting layer. The light-emitting layer may be located between the anode electrode and the cathode electrode. After the data signal transmitted through the j-th data line DLj is reflected in the voltage of the second node N2, when the emission control signal of the i-th emission control line ELi is enabled to the logic low level, the third transistor T3 may be turned on. In addition, the first transistor T1 may be turned on according to the voltage of the second node N2, and thus a current may flow from the first power voltage node VDDN to the second power voltage node VSSN. The light-emitting element LD may emit light according to an amount of the flowing current.

FIG. 5 is a block diagram illustrating one or more embodiments of the gate driver and the voltage generator shown in FIG. 2.

Referring to FIGS. 4 and 5, the gate driver 120 of FIG. 2 may include a first sub-gate driver 121, a second sub-gate driver 122, and an emission driver 123.

The first sub-gate driver 121 may receive a first gate start signal FLM1, and may generate the first sub-gate signal GW while shifting the first gate start signal FLM1 in response to a clock signal. The first sub-gate driver 121 may sequentially supply the first sub-gate signal GW to first sub-gate lines SGL11 to SGL1m.

The second sub-gate driver 122 may receive a second gate start signal FLM2, and may generate the second gate signal EB while shifting the second gate start signal FLM2 in response to a clock signal. The second sub-gate driver 122 may sequentially supply the second sub-gate signal EB to second sub-gate lines SGL21 to SGL2m.

The emission driver 123 may receive an emission start signal EFLM, and may generate the emission control signal while shifting the emission start signal EFLM in response to a clock signal. The emission driver 123 may sequentially supply the emission control signal EM to emission control lines EL1 to ELm.

The voltage generator 140 may supply a first low voltage VGL1 to the first sub-gate driver 121 and the emission driver 123, and may supply a second low voltage VGL2 to the second sub-gate driver 122.

The first low voltage VGL1 may be a voltage of the logic low level of the first gate signal GW and the emission control signal EM. The second low voltage VGL2 may be a voltage of the logic low level of the second gate signal EB. The second low voltage VGL2 may be lower than the first low voltage VGL1.

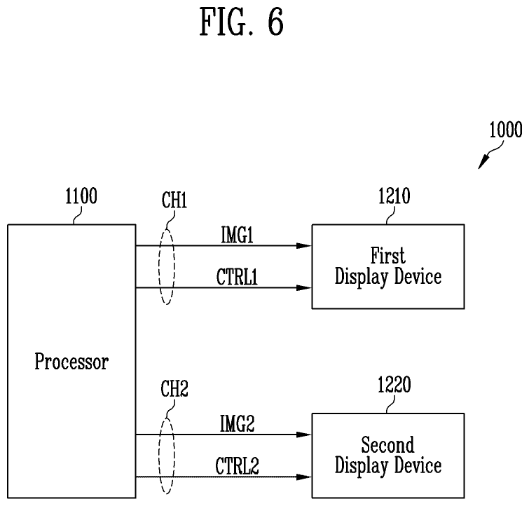

FIG. 6 is a block diagram illustrating one or more embodiments of a display system.

Referring to FIG. 6, the display system 1000 may include a processor 1100 and one or more display devices 1210 and 1220.

The processor 1100 may perform various tasks and calculations. In embodiments, the processor 1100 may include an application processor, a graphic processor, a microprocessor, a central processing unit (CPU), and the like. The processor 1100 may be connected to other components of the display system 1000 through a bus system and may control the other components.

In FIG. 6, the display system 1000 includes the first and second display devices 1210 and 1220. The processor 1100 may be connected to the first display device 1210 through a first channel CH1 and may be connected to the second display device 1220 through a second channel CH2.

Through the first channel CH1, the processor 1100 may transmit first image data IMG1 and a first control signal CTRL1 to the first display device 1210. The first display device 1210 may display an image based on the first image data IMG1 and the first control signal CTRL1. The first display device 1210 may be configured similarly to the display device 100 described with reference to FIG. 2. In this case, the first image data IMG1 and the first control signal CTRL1 may be provided as the input image data IMG and the control signal CTRL of FIG. 2, respectively.

Through the second channel CH2, the processor 1100 may transmit second image data IMG2 and a second control signal CTRL2 to the second display device 1220. The second display device 1220 may display an image based on the second image data IMG2 and the second control signal CTRL2. The second display device 1220 may be configured similarly to the display device 100 described with reference to FIG. 2. In this case, the second image data IMG2 and the second control signal CTRL2 may be provided as the input image data IMG and the control signal CTRL of FIG. 2, respectively.

The display system 1000 may include a computing system providing an image display function, such as a portable computer, a mobile phone, a smart phone, a tablet personal computer (PC), a smart watch, a watch phone, a portable multimedia player (PMP), a navigation device, and an ultra-mobile personal computer (UMPC). In addition, the display system 1000 may include at least one of a head-mounted display (HMD) device, a virtual reality (VR) device, a mixed reality (MR) device, and an augmented reality (AR) device.

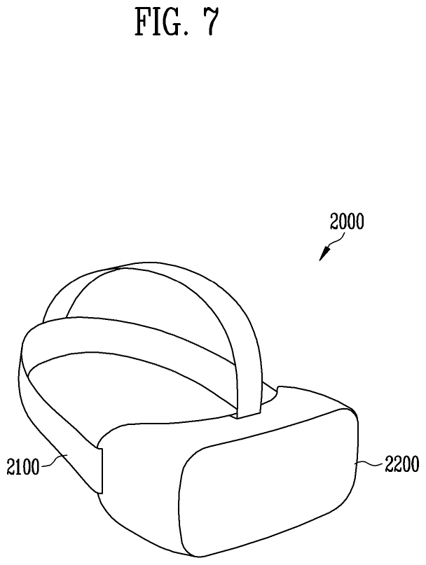

FIG. 7 is a perspective view illustrating an application example of the display system of FIG. 6.

Referring to FIG. 7, the display system 1000 of FIG. 6 may be applied to a head-mounted display device 2000. The head-mounted display device 2000 may be a wearable electronic device that may be worn on a user's head.

The head-mounted display device 2000 may include a head mount band 2100, and a display-device-receiving case 2200. The head mount band 2100 may be connected to the display-device-receiving case 2200. The head mount band 2100 may include a horizontal band and/or a vertical band for fixing the head-mounted display device 2000 to the user's head. The horizontal band may be configured to surround a side portion of the user's head, and the vertical band may be configured to surround an upper portion of the user's head. However, embodiments are not limited thereto. For example, the head mount band 2100 may be implemented in a glasses frame form, a helmet form, or the like.

The display-device-receiving case 2200 may receive the first and second display devices 1210 and 1220 of FIG. 6. The display-device-receiving case 2200 may further receive the processor 1100 of FIG. 6.

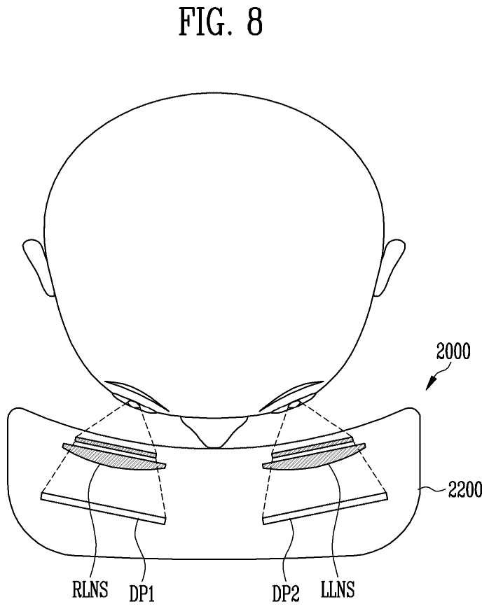

FIG. 8 is a diagram illustrating the head-mounted display device worn by a user of FIG. 7.

Referring to FIG. 8, in a head-mounted display device 2000, a first display panel DP1 of the first display device 1210 and a second display panel DP2 of the second display device 1220 are located. The head-mounted display device 2000 may further include one or more lenses LLNS and RLNS.

Within the display-device-receiving case 2200, the right eye lens RLNS may be located between the first display panel DP1 and a user's right eye. Within the display-device-receiving case 2200, the left eye lens LLNS may be located between the second display panel DP2 and a user's left eye.

An image output from the first display panel DP1 may be displayed to the user's right eye through the right eye lens RLNS. The right eye lens RLNS may refract light from the first display panel DP1 to be directed toward the user's right eye. The right eye lens RLNS may perform an optical function for adjusting a viewing distance between the first display panel DP1 and the user's right eye.

An image output from the second display panel DP2 may be displayed to the user's left eye through the left eye lens LLNS. The left eye lens LLNS may refract light from the second display panel DP2 to be directed toward the user's left eye. The left eye lens LLNS may perform an optical function for adjusting a viewing distance between the second display panel DP2 and the user's left eye.

In embodiments, each of the right eye lens RLNS and the left eye lens LLNS may include an optical lens having a pancake-shaped cross-section. In embodiments, each of the right eye lens RLNS and the left eye lens LLNS may include a multi-channel lens including sub-areas having different optical characteristics. In this case, each display panel may output images respectively corresponding to the sub-areas of the multi-channel lens, and the output images may pass through the respective corresponding sub-areas and may be viewed to the user.

Although some embodiments and application examples are described herein, other embodiments and modifications may be derived from the above description. Therefore, the spirit of the disclosure is not limited to such embodiments, and extends to the scope of the claims set forth below, various obvious modifications, and functional equivalents.

What is claimed is:

1. A sub-pixel comprising:
a first transistor connected between a first power voltage node and a first node, and comprising a gate terminal connected to a second node;
a second transistor connected between the second node and a data line, and comprising a gate terminal connected to a first sub-gate line;
a fourth transistor connected between the first node and an initialization voltage node, and comprising a gate terminal connected to a second sub-gate line; and
a light-emitting element connected between the first node and a second power voltage node,
wherein a logic low level of a first sub-gate signal configured to be received by the first sub-gate line is different from a logic low level of a second sub-gate signal configured to be received by the second sub-gate line.

2. The sub-pixel according to claim 1, wherein a voltage of the logic low level of the second sub-gate signal is less than a voltage of the logic low level of the first sub-gate signal.

3. The sub-pixel according to claim 1, wherein an initialization voltage of the initialization voltage node is less than a voltage of the logic low level of the first sub-gate signal.

4. The sub-pixel according to claim 3, wherein the initialization voltage is greater than or equal to a voltage of the logic low level of the second sub-gate signal.

5. The sub-pixel according to claim 4, further comprising a third transistor connected between the first power voltage node and a third node, and comprising a gate terminal connected to an emission control line,
wherein the first transistor is connected between the third node and the first node.

6. The sub-pixel according to claim 5, wherein the logic low level of the second sub-gate signal configured to be received by the second sub-gate line is different from a logic low level of an emission control signal configured to be received by the emission control line.

7. The sub-pixel according to claim 6, wherein a voltage of the logic low level of the second sub-gate signal is less than a voltage of the logic low level of the emission control signal.

8. The sub-pixel according to claim 7, wherein the initialization voltage is less than the voltage of the logic low level of the emission control signal.

9. The sub-pixel according to claim 5, wherein the first transistor, the second transistor, and the third transistor comprise a metal-oxide-semiconductor field-effect transistor comprising a body electrode.

10. The sub-pixel according to claim 9, wherein a first power voltage configured to be received by the first power voltage node is configured to be supplied to the body electrode of the first transistor, the second transistor, and the third transistor.

11. The sub-pixel according to claim 5, further comprising:
a first capacitor connected between the second node and the third node;
a second capacitor connected between the second node and a reference power voltage node; and
a third capacitor connected between the first node and the second node.

12. A display device comprising:
a display panel comprising a sub-pixel connected to a first sub-gate line and to a second sub-gate line;
a first sub-gate driver configured to supply a first sub-gate signal to the sub-pixel through the first sub-gate line; and
a second sub-gate driver configured to supply a second sub-gate signal to the sub-pixel through the second sub-gate line,
wherein the sub-pixel comprises:
a first transistor connected between a first power voltage node and a first node, and comprising a gate terminal connected to a second node;
a second transistor connected between the second node and a data line, and comprising a gate terminal connected to the first sub-gate line;
a fourth transistor connected between the first node and an initialization voltage node, and comprising a gate terminal connected to the second sub-gate line; and
a light-emitting element connected between the first node and a second power voltage node, and
wherein a logic low level of the first sub-gate signal is different from a logic low level of the second sub-gate signal.

13. The display device according to claim 12, wherein a voltage of the logic low level of the second sub-gate signal is less than a voltage of the logic low level of the first sub-gate signal.

14. The display device according to claim 12, wherein an initialization voltage of the initialization voltage node is less than a voltage of the logic low level of the first sub-gate signal.

15. The display device according to claim 14, wherein the initialization voltage is greater than or equal to a voltage of the logic low level of the second sub-gate signal.

16. The display device according to claim 15, further comprising an emission driver configured to supply an emission control signal to the sub-pixel through an emission control line,
wherein the sub-pixel further comprises a third transistor connected between the first power voltage node and a third node, and comprising a gate terminal connected to the emission control line, and
wherein the first transistor is connected between the third node and the first node.

17. The display device according to claim 16, wherein the logic low level of the second sub-gate signal configured to be received by the second sub-gate line is different from a logic low level of the emission control signal configured to be received by the emission control line.

18. The display device according to claim 17, wherein a voltage of the logic low level of the second sub-gate signal is less than a voltage of the logic low level of the emission control signal.

19. The display device according to claim 18, wherein the initialization voltage is less than the voltage of the logic low level of the emission control signal.

20. The display device according to claim 16, further comprising:
a first capacitor connected between the second node and the third node;
a second capacitor connected between the second node and a reference power voltage node; and
a third capacitor connected between the first node and the second node.

21. An electronic device comprising a sub-pixel comprising:
a first transistor connected between a first power voltage node and a first node, and comprising a gate terminal connected to a second node;
a second transistor connected between the second node and a data line, and comprising a gate terminal connected to a first sub-gate line;
a fourth transistor connected between the first node and an initialization voltage node, and comprising a gate terminal connected to a second sub-gate line; and
a light-emitting element connected between the first node and a second power voltage node,
wherein a logic low level of a first sub-gate signal configured to be received by the first sub-gate line is different from a logic low level of a second sub-gate signal configured to be received by the second sub-gate line.

22. The electronic device of claim 21, wherein the electronic device comprises a smartphone, a television, a monitor, a tablet, an electric vehicle, a mobile phone, a tablet personal computer (PC), a mobile communication terminal, an electronic notebook, an electronic book, a portable multimedia player (PMP), a navigation device, an ultra-mobile PC (UMPC), a laptop computer, a billboard, an Internet of Things (IoT) device, a smartwatch, a watch phone, a head-mounted display (HMD), a virtual reality (VR) device, or an augmented reality (AR) device.
